(19) United States
(12) Patent Application Publication
(10) Pub. No.: US 2012/0252924 A1
(43) Pub. Date: Oct. 4, 2012

(54) FLAVORED SILICONE PRODUCTS

(76) Inventor: CASSANDRA ANN MAHONEY, UXBRIDGE, MA (US)

(21) Appl. No.: 13/423,189

(22) Filed: Mar. 17, 2012

Related U.S. Application Data
(60) Provisional application No. 61/469,048, filed on Mar. 29, 2011.
(60) Provisional application No. 61/471,170, filed on Apr. 3, 2011.

(51) Int. Cl. C08L 83/00

(52) U.S. Cl. 523/105

(57) ABSTRACT

A system for flavoring silicone products, such as baby bottle nipples and baby pacifiers, and a system for forming the flavored silicone products. Flavors, in the form of esters, are bond to Silicon (IV) Oxide, the resulting flavored intermediate is mixed into silicone, and the mixture is formed into a flavored product.

### CROSS-REFERENCE TO RELATED APPLICATIONS

This application claims the benefit under 35 U.S.C. §119(e) of U.S. Provisional Application No. 61/469,048 filed Mar. 29, 2011, and, U.S. Provisional Application No. 61/471,170 filed Apr. 3, 2011 both of which is hereby incorporated by reference.

### STATEMENT REGARDING FEDERALLY SPONSORED RESEARCH OR DEVELOPMENT

This invention has been created without the sponsorship or funding of any federally sponsored research or development program.

### FIELD OF THE INVENTION

This invention involves flavored silicone products, such as baby bottle nipples and baby pacifiers, and a system for forming them.

### BACKGROUND OF THE INVENTION

Silicone has become a very popular material from which to make baby bottle nipples, baby teethers and pacifiers, and other products that come into contact with oral tissue, because it can be made free of potentially toxic impurities, and because the products can be sanitized. However, such silicone has no flavor and the absence of flavor can be unattractive to users, especially babies. The chemical inertness and chemical structure of silicone makes if difficult to cause the silicone to have an attractive flavor.

These and other difficulties experienced with the prior art devices have been obviated in a novel manner by the present invention.

It is, therefore, an outstanding object of some embodiments of the present invention to provide a system for forming flavored silicone products in an efficient and effective manner.

Another object of some embodiments of the present invention is to provide a system for forming silicone products, that can display a wide range of flavors.

With these and other objects in view, as will be apparent to those skilled in the art, the invention resides in the combination of parts set forth in the specification and covered by the claims appended hereto, it being understood that changes in the precise embodiment of the invention herein disclosed may be made within the scope of what is claimed without departing from the spirit of the invention.

### BRIEF SUMMARY OF THE INVENTION

This invention is a system for flavoring silicone products, such as baby bottle nipples and baby pacifiers, and a system for forming the flavored silicone products. Flavors, in the form of esters, are bond to Silicon (IV) Oxide, the resulting flavored intermediate is mixed into silicone, and the mixture is formed into a flavored product.

### BRIEF DESCRIPTION OF THE DRAWINGS

The character of the invention, however, may best be understood by reference to one of its structural forms, as illustrated by the accompanying drawings, in which:

FIG. 1 is shows a diagram of the Silicon (IV) Oxide structure,

FIG. 2 represents the esterification reaction in which a carboxylic acid reacts with an alcohol to form an ester and water.

FIG. 3 represents the reversible equilibrium esterification reaction in the presence of acid.

FIG. 4 shows Table 1 which shows the formula, enthalpy of fusion, enthalpy of vaporization and boiling point for silica.

FIG. 5 shows Table 2 which shows common esters that could be used in silicone in order to add specific tastes that would be great flavoring agents for this product.

FIG. 6 shows Table 3 which shows the amounts of certain acids and alcohols needed in order to make a given ester.

FIG. 7 shows a flow chart representing the steps of a process for making a flavored silicone product, the process and the product incorporating some of the principles of the present invention.

FIG. 8 shows plan view of a flavored silicone baby pacifier incorporating some of the principles of the present invention.

### DETAILED DESCRIPTION OF THE INVENTION

This invention is a system for flavoring silicone products, such as baby bottle nipples and baby pacifiers, and a system for forming the flavored silicone products. In the preferred embodiment of the invention, flavors, in the form of esters, are bond to Silicon (IV) Oxide, the resulting flavored intermediate is mixed into silicone, and the mixture is formed into a flavored product.

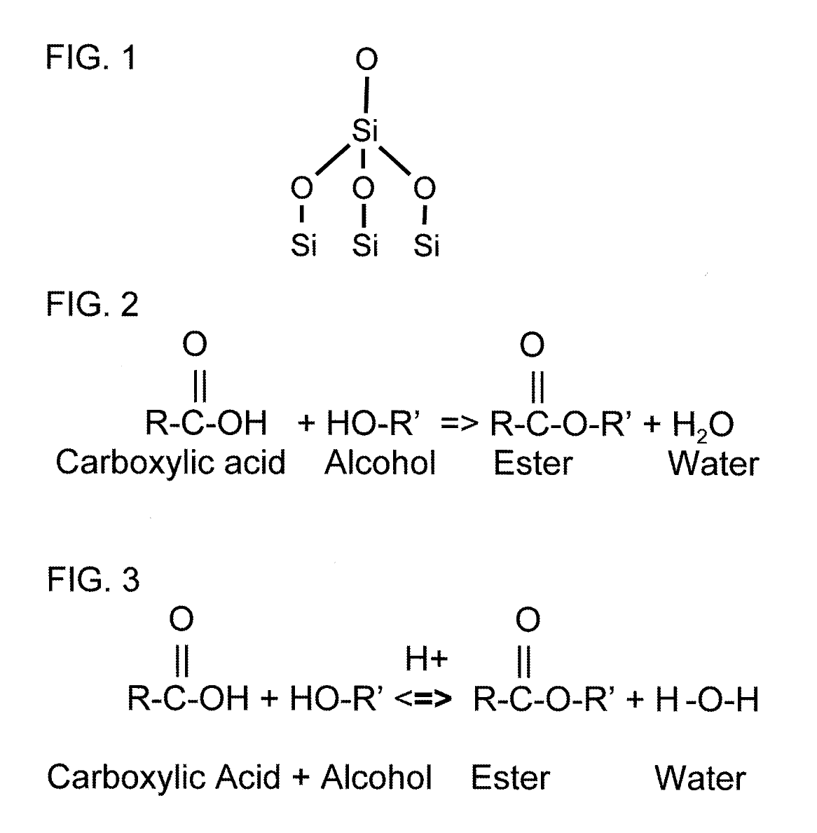

Silicon (IV) Oxide would work as a Binder between the flavor and the silicone due to the following factors, 1. the molecular structure consists of giant covalent network/lattice with strong single bonds in all directions forming ‘3D’ links, 2. the melting point for this covalent bond system requires far more thermal energy to break the strong bonds in order to weaken the lattice, 3. it is insoluble in all solvents. Due to the strong 3D covalent bond network, the solvation process does not release enough energy to break it apart. FIG. 1. Show Silicon bonded to 4 oxygen atoms.

Now this is why it can work. Silicon is part of the carbon family and shares similar characteristics. A graphite structure is a layered 2 dimensional strong bond network made of layers of joined hexagonal rings of carbon atoms. These carbon atoms have weak inter-molecular forces between the layers. Silicon dioxide (SiO₂) has a similar 3D structure and properties to carbon (diamond). The structure of the three allotropes of Carbon (diamond, graphite and fullerens), Silicon and Silicon dioxide makes it possible for many atoms to link up and form a giant covalent structure/lattice. These atoms that link up are usually non-metals.

In doing this, a strong 3-Dimensional covalent bond network/lattice is produced, giving elements significantly different properties from the small simple covalent molecules they once were. This is important due to most non-metal elements and noble gases being single atoms. Being monatomic, they have no free ions or electrons for covalent bonding in the molecules.

This happens because weak intermolecular forces all have relatively low melting points as well as boiling points. Some examples of these are P₄, S₈, N₂, and O₂. They will dissolve in solvents and are electrical insulators making them no good to use previous to our altering their properties. Using one of the allotropes of carbon (diamond) this can be seen due to the similarities in structure of carbon and silicon. Having four outer electrons that form four single bonds, carbon allows each carbon to bond to four others by electron pairing and sharing.

The two most abundant elements in the earth's crust are oxygen and silicon. Many naturally occurring minerals are based on —O—X—O— linked 3D structures where ‘X’ is often Silicon. Keeping in mind that most infant formulas are alike, Similac® Sensitive® (for fussiness and gas) will be used to state the information in order to show one of the many possibilities of flavored Pacifiers, Milk Flavored. The minerals found in this formula are Calcium, Phosphorous, Magnesium, Iron, Zinc, Manganese, Copper, Iodine, Selenium, Sodium, Potassium, and Chloride. Silicon in its melted state combines with phosphorous, oxygen, nitrogen and sulfur. Silicon always occurs as a compound with magnesium, calcium and phosphorous. These are all found in the formula as well. Sodium is found in the formula and silicon has a mild reaction to NaOH.

Doping can be used to get phosphorous to bind to silicon through electric current by forming an n-type semiconductor. Phosphorous has five valence electrons whereas silicon has only four. By doping silicon with phosphorous, a few silicon atoms in the solid are replaced with phosphorous atoms. After each phosphorous atom bonds to four silicon atoms, an electron is left over. The extra electrons in phosphorous-doped silicon are free to conduct an electric current. Phosphorous is found in the Similac® formula.

Another example of how to bind silicon to an element that has less valence electrons then its four is using a p-type semiconductor. Boron has only three valence electrons to silicon's four. After the boron atom forms bonds to four silicon atoms, one of the boron-silicon atoms has only one electron in it. Since the orbital has a vacancy for an electron, an electron from a neighboring atom can move to occupy this hole. This leaves a hole on the neighboring atom and an electron from an atom next to it can now occupy that hole.

In order to get these elements mixed and bound into the silicone, the silicon (IV) oxide needs to reach its melting point. Its melting point is 1883K/1610° C. Due to its strong 3D covalent bond system, the temperature to reach its melting point must be very high in order to break the strong bonds that will weaken the lattice. For strongly bonded 3D networks (such as an ionically bonded lattice of ions, a covalently bonded lattice of ions or a metal lattice of ions and free outer electrons) the structures are much stronger in a continuous way throughout the structure and consequently much greater energies are required to melt or vaporize the material.

Included (See Table 1) are key components to Silica that are important such as the enthalpy of vaporization, enthalpy of fusion, and boiling point. Enthalpy of fusion (DHₘₑₗₜ) is the energy needed to melt 1 mole of the substance whose formula mass is in grams. Enthalpy of vaporization (DHᵥₐₚ) is the energy needed to vaporize by evaporation or boiling 1 mole of the substance (also in grams).

Doping: Used to get phosphorous to bind to silicon through electric current by forming n-type semiconductor. By doping silicon with phosphorous, a few silicon atoms in the solid are replaced with phosphorous atoms. After each phosphorous atom bonds to four silicon atoms, an electron is left over. The extra electrons in phosphorous-doped silicon are free to conduct an electric current. Binding silicon to an element that has less valence electrons then its four using a p-type semiconductor. Since the orbital has a vacancy for an electron, an electron from a neighboring atom can move to occupy this hole. This leaves a hole on the neighboring atom and an electron from an atom next to it can now occupy that hole. In order to get these elements mixed and bound into the silicone, the silicon (IV) oxide needs to reach its melting point. Its melting point is 18831K/1610° C. Due to strong 3D covalent bond system, temperature to reach its melting point must be very high in order to break the strong bonds that will weaken the lattice. To get flavoring to bind to silicone, Esters will be used.

Doping has a couple different ways to do the process as seen. In basic words, heat the silicone to extreme temperatures to break the bonds, you will be able to add Esters (flavors). Once the Silicone cools, the bonding system is strong, holding strong to the Esters.

To get flavoring to bind to the silicone, esters will be used. It's a compound formed from a carboxylic acid, RCOOH, and an alcohol, RCOH (Ebbing/Gammon, 1027). It's any class of organic compounds that react with water to produce alcohol and inorganic/organic acids. Being derived from carboxylic acids, these chemicals have the ability to carry the bulk of the taste and/or smell signal. Other chemicals would be added in the correct proportion to obtain a more realistic flavor by either trial and error or chemical analysis.

FIG. 2 represents the esterification reaction in which a carboxylic acid reacts with an alcohol to form an ester and water. Esterification would be used in order to prepare the carboxylic acid esters for replacement of the hydroxyl group (OH) by the alkoxy group (R′O) of the alcohol. The reaction of carboxylic acids and alcohols is typically done in the presence of hydrochloric acid or sulfuric acid.

FIG. 3 represents the reversible equilibrium esterification reaction in the presence of acid.

Hydrolysis (reverse of esterification reaction) can also be used in order to obtain esters. The hydrolysis of an ion is the reaction of an ion with water to produce the conjugate acid and hydroxide ion or the conjugate base and hydronium ion (Ebbing/Gammon, 705). It would be seen in the reaction of acid halides or acid anhydrides with alcohols. It could also be seen by the reaction of salts of carboxylic acids with alkyl halides. Transesterification could also be used to convert one ester to another, to obtain more of a specific flavor. There would need to be a reaction with an alcohol, carboxylic acid, or a third ester in the presence of a catalyst.

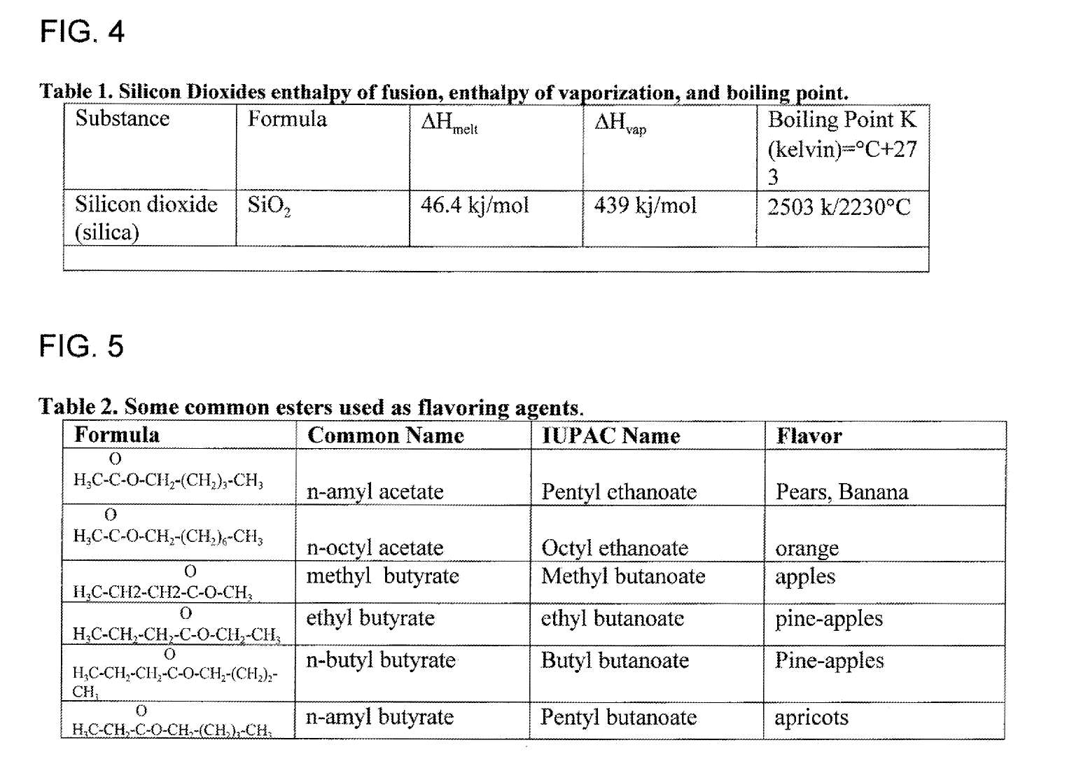

FIG. 4, Table 1 shows the formula, enthalpy of fusion, enthalpy of vaporization and boiling point for silica. These are necessary in order to obtain a substance to binding flavor.

FIG. 5, Table 2 shows common esters that could be used in silicone in order to add specific tastes that would be great flavoring agents for this product. Besides milk based (infant formula) there are so many possibilities for the flavored pacifier. The focus is on fruit since most infants eat stage-2 baby food, which comes in fruit flavors.

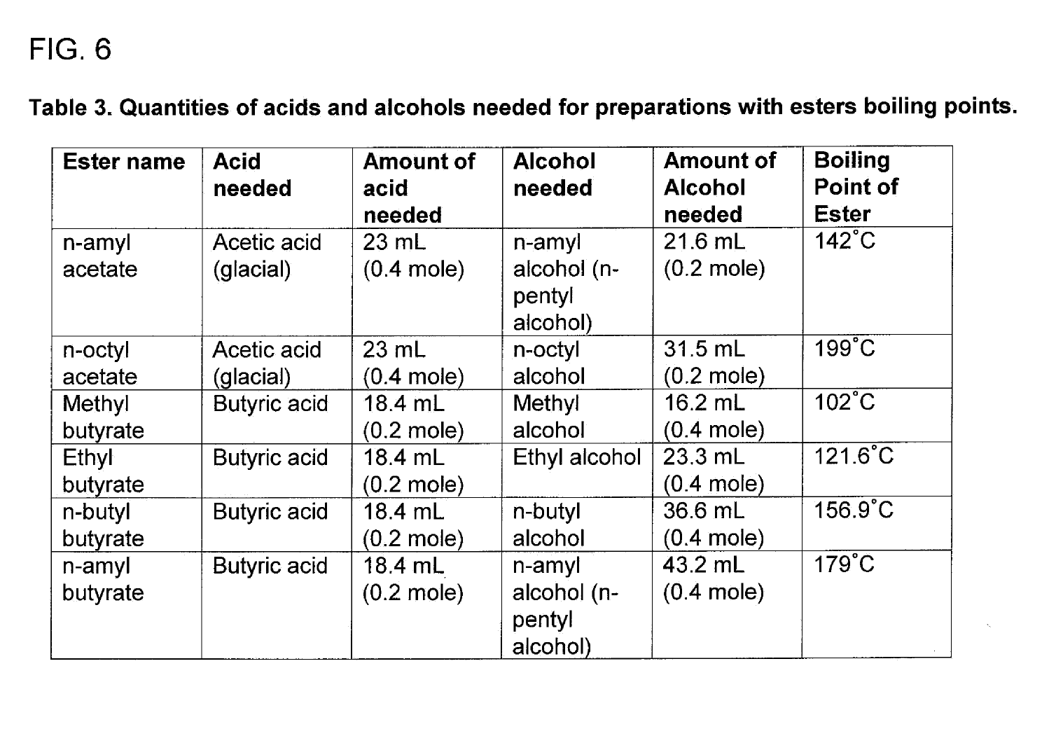

FIG. 6, Table 3 shows the amounts of certain acids and alcohols needed in order to make a given ester. The boiling points are also given due to the non-ability to obtain the end result without such.

In conclusion, by using Silicon (IV) Oxide as a binder to silicone, we would be able to add flavor to silicone while being able to maintain its composure based on the 3D network molecular structure. By using mechanisms such as Doping and esterification we will be able to manipulate the atoms in order to obtain a specific product. The use of Esters in silicone will give the flavor agent that we need in order to have a successful end result. Whether its milk, fruit or any flavor pacifiers the possibilities are endless. By having the correct melting point and boiling point of Silicone, the ability to make flavor bind is possible and achievable.

Flavored teethers are even an option. Based on the idea that there are two types of teethers (Plastic and water), manipulation of the teether of choice is attainable to achieve flavor. There are already animal and fruit shaped teethers available for infants but why not take it one step further and add flavor to them. Most teethers are made from special food grade plastic which is non-toxic, durable and (in the situation of having a water teether) the contents in the teether are safe for drinking. This new type of teether would not only have a soothing impact on the child's gums but it will also improve their learning skills by the various shapes and help the child acquire smart food habits.

This is such a great idea and will be successful due to the needs of both infants and parents (especially the mommies!). The last thing I′ d want is a crying baby that's crying not because he's hungry, but because he enjoys the taste of his formula. I noticed when he was a couple months old that he enjoyed having the silicone nipple of his bottle in his mouth but he would spit out his milk because he wasn't hungry but he was comforted by the taste of his food. As soon as I took the bottle away he would cry because I was taking away what he wanted, needed, and enjoyed at that moment. In that moment of fussy-crying-baby-driving-his-mama-bananas I said “I wish I had a milk flavored binki.” I′ ve talked to a few trust worthy friends who wouldn't sugar coat something in wanting to not hurt ones feelings or let me put my heart into something that I would waste my free time (time I had when Ashton was sleeping in the middle of the night . . . my time to sleep. Haha) on because lets be honest, being a parent there is no free time. You just want what we all want, a happy, healthy baby. Talking to people I′ ve heard from many that they think it would be an awesome idea, and they wished they had that product available to them when they had little ones. Think of the satisfaction a child gets when they have a lollipop. It's the same thing minus the stickiness and the candy part. Instead we replace the unhealthy sugary-tasting-sticky treat with a delicious new flavor like bananas, milk, apples, oranges, pears or apricots. It teaches babies good eating habits because they are going to be enjoying something that is not only good for them but also beneficial for their eating habits throughout their life. Teach them when they are young because this is when they learn the most. In a country that's dealing with problems of childhood obesity this is the next thing that can teach kids about healthy eating.

It should be easy to manufacture because we have all of these materials available. We already have the pacifier design and the silicone nipple, just add the flavoring agent into the silicone. The possibility for flavored silicone is excellent. It can and will be created. The abundance of silicon in our earth has made it an easy find for a sweet-healthy comfort aid to an infant. Happy baby=Happy parent!

Now your probably asking yourself, Why should I believe and invest in this product? This product (flavored pacifier) has what people have been looking for. It's convenient, affordable, and health conscious. Based on the age of the infant/toddler you would start off with the milk flavored pacifier and as the parent introduced foods into their diet (around four months of age), the specific flavored pacifier that has been created with your baby in mind based on the food that they like to eat would work to comfort while it teaches your baby at the same time. In a country that's dealing with a childhood obesity epidemic, this is our saving grace. By letting infants taste and enjoy the flavor of fruits, milk (and other possibilities such as vegetable flavors) they are being taught young that these foods are good and they will be able to acquire the taste for them so when they are older they will be able to make health conscious choices on their preference of food because of the pacifier that you provided for them as an infant. This is the first stepping stone for a healthier world, population, society and of course individual.

The flavored silicone product has portion that is formed of silicone, that contains a dispersion of fine doped silica, to which silica, flavor has been bound. The doped silica by adding a dopant to the silica, the dopant having a different number of valence electrons, to the Silicon, to replace some of the Silicon, and to thereby form a polar structure. The flavoring, preferably in the form of an ester, is bonded to the polar doped silica, that is in turn, mixed into the silicone. When the silicone is placed in a baby's mouth, the flavoring is released from the silica, and the baby taste the flavor.

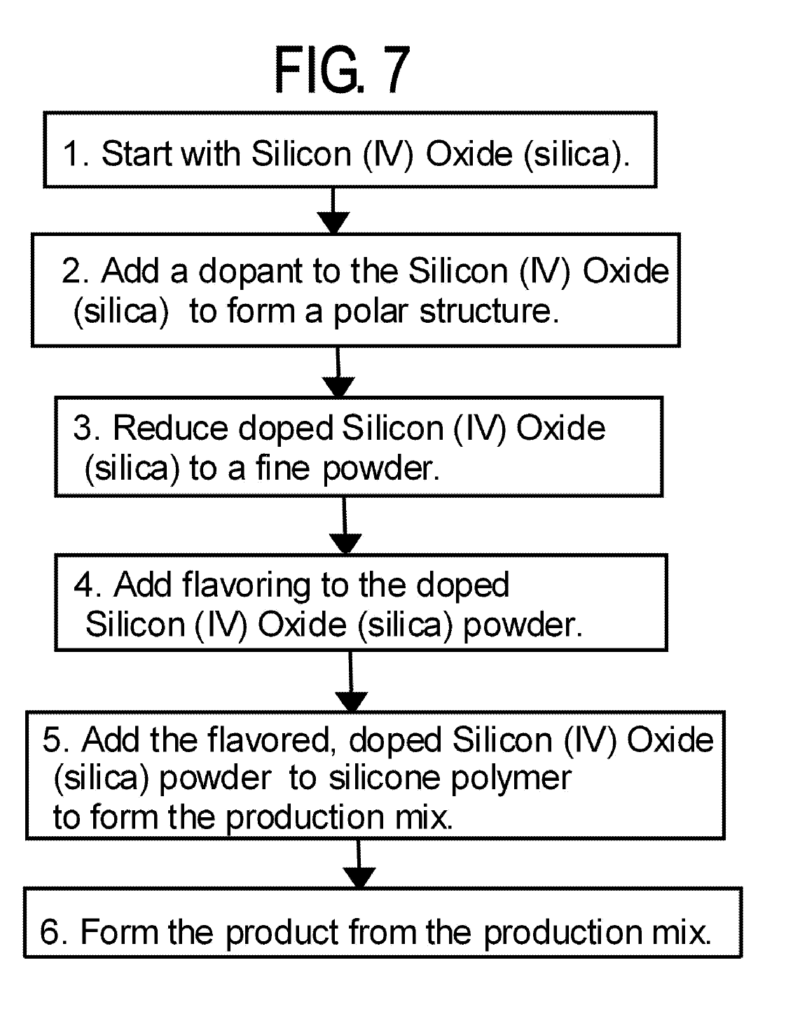

Here is a simple statement of the steps of one embodiment of the process of the present invention to make a flavored silicone product, as shown in FIG. 7.

1. Start with Silicon (IV) Oxide (silica). 2. Add a dopant, having a different number of valence electrons, to the Silicon (IV) Oxide (silica), to replace some of the silicon, and to thereby form a polar structure. 3. Reduce doped Silicon (IV) Oxide (silica) to a fine powder, made up of particles with polar surfaces. 4. Add flavoring to the doped Silicon (IV) Oxide (silica) powder, so that the flavoring is attracted to the polar surface of the particles. 5. Add the flavored, doped Silicon (IV) Oxide (silica) powder to silicone polymer to form the production mix. 6. Form the product from the production mix.

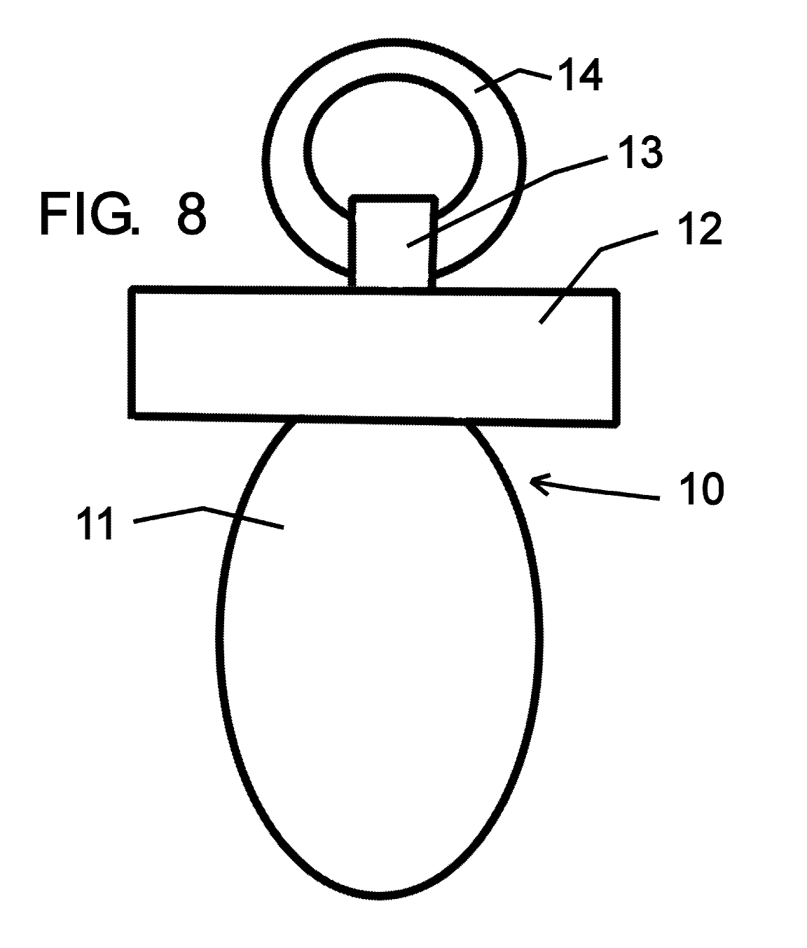

One embodiment of this invention is the pacifier 10, shown in FIG. 8. It is made up of a flavored silicone teething element 11, and a flange 12, attached to the teething element 11 and designed to prevent a child from swallowing the teething element 11. On the side of the flange 12 opposite the teething element 11, is a handle holder 13, that holds a handle 14.

Work cited: General Chemistry, Media enhanced edition, eighth edition. By Darrell D. Ebbing and Steven D. Gammon, Copyright 2008 by Houghton Mifflin Company, Doping (pg. 543), Websites Referenced: http://www.docbrown.info/page04/4_{—}72bond4.htm, concerning bonding in polymers, and strong bond networks, and Http://www.Britannica.com/Ebchecked/topic/193393/ester, concerning Esters.

It is obvious that minor changes may be made in the form and construction of the invention without departing from the material spirit thereof. It is not, however, desired to confine the invention to the exact form herein shown and described, but it is desired to include all such as properly come within the scope claimed.

The invention having been thus described, what is claimed as new and desire to secure by Letters Patent is:

1. An system for forming a flavored silicone product, comprising the steps of:
a. forming a doped silica powder, by incorporating into the structure of the silica, a element having a different number of valence electrons that silicon, to replace some of the silicon, and to thereby form a polar doped silica structure,
b. adding the doped silica powder and flavor to silicone to form a product mix, and
c. forming the product mix into a flavored silicone product.

2. A system as recited in claim 1, wherein the element is Phosphorous.

3. A system as recited in claim 1, wherein the element is Boron.

4. A system as recited in claim 1, wherein the flavor is polar.

5. A system as recited in claim 1, wherein the flavor is an ester.

6. A flavored silicone product, comprising:
a. a portion that is formed of silicone,
b. said portion also including a doped silica in which some of the silicon is replaced by an element having a valence different from silicon so that the silica is polar, and
c. an flavor.

7. A system as recited in claim 1, wherein the element is Phosphorous.

8. A system as recited in claim 1, wherein the element is Boron.

9. A system as recited in claim 1, wherein the flavor is polar.

10. A system as recited in claim 1, wherein the flavor is an ester.
